(19) United States
(12) Patent Application Publication
(10) Pub. No.: US 2020/0099861 A1
(43) Pub. Date: Mar. 26, 2020

(54) Method, Device, and System for Correcting Distortion of an Optical Signal Caused by Atmospheric Turbulence

(71) Applicant: United States of America as represented by the Secretary of the Navy, San Diego, CA (US)

(72) Inventors: David T. Wayne, San Diego, CA (US); Galen Cauble, San Diego, CA (US)

(21) Appl. No.: 16/140,503

(22) Filed: Sep. 24, 2018

(51) Int. Cl. H04N 5/232; G02B 7/28

(52) U.S. Cl. CPC H04N 5/23258; G03B 3/10; H04N 5/23212; G02B 7/285

(57) ABSTRACT

An optical signal passing through an atmosphere is received by a liquid lens. Distortion of the received optical signal caused by turbulence in the atmospheric is measured. Adjustments of either or both of the focal length and the focal position of the liquid lens needed to correct for the distortion are determined. Either or both of the focal length and the focal position of the liquid lens are adjusted to correct for the distortion.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil, referencing Navy Case 103746.

### FIELD OF THE INVENTION

The present disclosure pertains generally to correction of distortion in an optical signal. More particularly, the present disclosure pertains to correction of distortion in an optical signal caused by atmospheric turbulence.

### BACKGROUND

The performance of an electro-optical detector is limited by the conditions of the atmosphere it must operate in. When an optical signal travels through an atmosphere, atmospheric turbulence induces distortion in the optical signal. Such distortion can cause a loss of intensity at the detector, due to beam wander and defocusing.

Typically, such distortions are accounted for by increasing detector size, widening the field of view, or adding a fast-steering mirror. However, these solutions may increase the total cost and footprint of the electro-optical detector, degrade the detector's bandwidth, and reduce the signal to noise ratio.

In view of the above, it would be desirable to have a compact electro-optical detector that is capable of efficiently and accurately correcting for distortion in an optical signal caused by atmospheric turbulence.

### SUMMARY

According to an illustrative embodiment, an optical signal passing through an atmosphere is received by a liquid lens. Distortion of the received optical signal caused by turbulence in the atmosphere is measured. An adjustment of at least one of a focal length and a focal position of the liquid lens to correct for the distortion is determined. At least one of the focal length and the focal position of the liquid lens is adjusted to correct for the distortion.

These, as well as other objects, features and benefits will now become clear from a review of the following detailed description, the illustrative embodiments, and the accompanying drawings.

### BRIEF DESCRIPTION OF THE DRAWINGS

The novel features of the present disclosure will be best understood from the accompanying drawings, taken in conjunction with the accompanying description, in which similarly-referenced characters refer to similarly-referenced parts, and in which:

FIG. 1 illustrates a system for correcting distortion of an optical signal caused by atmospheric turbulence according to illustrative embodiments.

FIGS. 2A, 2B, and 2C depict side views of a liquid lens with different applied voltages according to an illustrative embodiment.

FIG. 3 is a flow chart depicting a process or method for correcting distortion of an optical signal caused by atmospheric turbulence according to an illustrative embodiment.

### DETAILED DESCRIPTION OF THE EMBODIMENTS

According to illustrative embodiments, distortion in an optical signal caused by atmospheric turbulence is efficiently corrected for using a liquid lens with an adjustable focal length and focal position. In particular, a liquid lens may be used to correct blur and tilt in an optical signal caused by atmospheric turbulence. This may be achieved by adjusting the focal length (i.e., the meniscus height) and the focal position (i.e., meniscus location on the liquid lens plane) of the liquid lens in response to feedback.

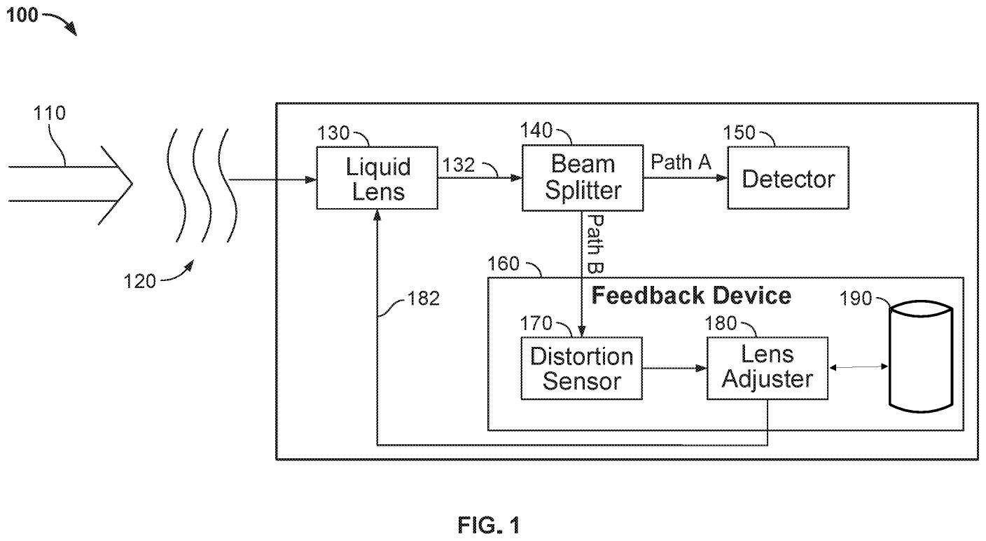

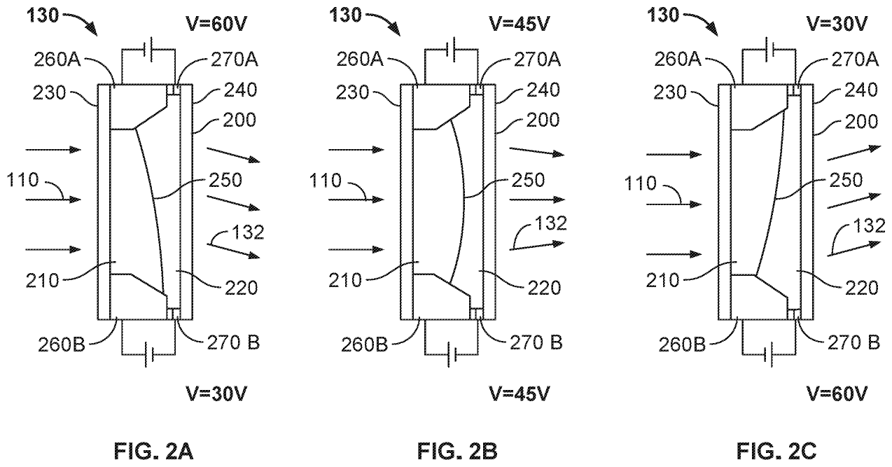

FIG. 1 illustrates a distortion correction system 100 for correcting distortion in a received optical signal 110 caused by atmospheric turbulence according to illustrative embodiments. The received optical signal 110 may be, for example, a laser beam. Referring to FIG. 1, the distortion correction system 100 includes at least one liquid lens 130 that receives the received optical signal 110 that has passed through an atmosphere 120 with turbulence. The liquid lens 130 has an adjustable focal length and focal position, as described in more detail below with reference to FIGS. 2A-2C.

The modified optical signal 132 exiting from the liquid lens 130 is split by a beam splitter 140 into two paths A and B. That is, the beam splitter 140 feeds the modified optical signal 132 through path A to a detector 150 that is configured to detect the modified optical signal 132. The beam splitter 140 also feeds the modified optical signal 132 via path B to a feedback device 160. The feedback device 160 is configured to measure distortion present in the received optical signal 110 caused by turbulence in the atmosphere 120 and to adjust at least one of a focal length and a focal position of the liquid lens 130 to correct for the distortion. The modified optical signal 132 may be continuously fed from the beam splitter 140 to the feedback device 160, and the focal length and/or the focal position of the liquid lens 130 may be continually adjusted by the feedback device 160 to correct for the blur and tilt of the received optical signal 110 as detected in the modified optical signal 132 that is fed to the detector 150.

According to the illustrative embodiment of the distortion correction system 100 shown in FIG. 1, the feedback device 160 includes a distortion sensor 170 and a lens adjustor 180. The distortion sensor 170 is configured to measure distortion of the modified optical signal 132. In particular, the distortion sensor 170 is configured to measure blur and tilt of the modified optical signal 132, which may be caused by atmospheric turbulence. The lens adjuster 180 is configured to determine an adjustment needed for the focal length and the focal position of the liquid lens 130 to correct for the measured blur and tilt, respectively, as described in more detail below. The lens adjuster 180 is further configured to output an adjustment signal 182 to the liquid lens 130 to cause the focal length and/or focal position of the liquid lens 130 to be adjusted as appropriate. This adjustment signal 182 may include one or more voltage signals that are applied to electrodes of the liquid lens 130, as described in more detail below with reference to FIGS. 2A-2C.

The distortion sensor 170 may be implemented with any suitable sensor or combination of sensors for detecting blur and tilt in the modified optical signal 132. The lens adjuster 180 may be implemented with any suitable component, such as a microprocessor for determining adjustments needed to correct for blur and tilt and outputting a signal to the liquid lens 130 as appropriate. In one embodiment, the lens adjuster 180 includes a signal processor that performs calculations based on the measured blur and tilt and provides voltage signals to the liquid lens 130 to adjust the focal length and focal position of the liquid lens 130 to correct for blur and tilt, respectively.

In one embodiment of the feedback device 160, the distortion sensor 170 includes a camera, such as a charge coupled device (CCD) camera, for measuring blur and tilt of the received optical signal. The camera measures blur of the received optical signal 110 by detecting a beam size of the modified optical signal 132. Blur is measured as deviation of the detected beam size of the modified optical signal 132 from an optimal beam size stored in a memory 190, such as a computer database. The camera measures tilt of the received optical signal 110 by detecting a beam position of the modified optical signal 132. Tilt is measured as a deviation of the detected beam position of the modified optical signal 132 from an optimal beam position or an expected beam position (e.g., a center position).

According to the embodiment of the feedback sensor described immediately above, the lens adjuster 180, which is also included in the camera, determines adjustment of the focal length of the liquid lens 130 needed to correct for the blur by comparing the detected beam size of the modified optical signal 132 received by the camera with an optimal beam or expected size stored in the memory 190. Similarly, the lens adjuster 180 determines adjustment of the focal position of the liquid lens 130 needed to correct for the tilt by comparing the detected beam position of the modified optical signal 132 with an optimal or expected beam position stored in memory 190. In one example embodiment, the lens adjuster 180 may include a microprocessor configured to perform such comparisons and to communicate with the memory 190, which is configured to store optimal or expected beam sizes and positions. The lens adjuster 180 and memory 190 may be included within the camera as an auto-focus component.

According to another embodiment of the distortion correction system 100, the distortion sensor 170 may be configured to detect a number of high frequency components within the modified optical signal 132 as a measure of blur. A sharper good quality optical signal has a higher number of high frequency components compared to a blurred optical signal. According to this embodiment, an optimal threshold number of high frequency components may be stored in memory 190, and the lens adjuster 180 may determine and perform adjustment of the focal length of the liquid lens 130 needed to correct for the blur by comparing the detected number of high frequency components within the received optical signal with the threshold optimal number of high frequency components. For this purpose, the lens adjuster 180 may include a microprocessor configured to perform such a comparison and to communicate with the memory 190, which is configured to store an optimal threshold number of high frequency components.

According to another embodiment of the distortion correction system 100, the distortion sensor 170 may include a simple image quality metric sensor that is configured to measure an image quality metric of the modified optical signal 132, such as sharpness. According to this embodiment, a reference or expected image quality level, such as a reference or expected sharpness level, is stored in memory 190. The lens adjuster 180 may determine adjustment of the focal length of the liquid lens 130 needed to correct for blur by comparing the measured sharpness of the modified optical signal 132 with the reference or expected sharpness level.

It should be appreciated that the distortion sensors described above are provided as examples. There may be other suitable distortion sensors that may be used to measure blur and tilt. For example, the distortion sensor 170 may include a wavefront sensor, such as a Shack-Hartmann wavefront sensor that includes a series of lenses that measure tilt of the modified optical signal 132 over a given plane. Another example of the distortion sensor 170 capable of measuring tilt is a quadrant cell detector.

Other suitable distortion sensors capable of measuring blur and/or tilt may be used, in conjunction with a suitable lens adjuster, to provide correction for blur and tilt by causing adjustment of the focal length and focal position of the liquid lens, respectively.

Although one liquid lens 130 is depicted in FIG. 1, it should be appreciated that more than one liquid lens may be used to correct for distortion. For example, a first liquid lens may be used to correct for blur, and a second liquid lens may be used to correct for tilt. Additionally, more liquid lenses may be used to provide for stronger correction.

Further, although one beam splitter 140 and one feedback device 160 are shown in FIG. 1, it should be appreciated that multiple beam splitters and feedback devices may be used in conjunction with one or more liquid lenses to correct for blur and tilt. For example, a first beam splitter and a first feedback device including a first distortion sensor and a first lens adjuster may be used in conjunction with a first liquid lens to correct for blur. A second beam splitter and a second feedback device including a second distortion sensor and a second lens adjuster may be used in conjunction with a second liquid lens to correct for tilt.

As noted above, the signal from the lens adjuster 180 that causes adjustment of the focal length and/or the focal position of the liquid lens 130 may include one or more voltages that are applied to electrodes of the liquid lens 130. This may be understood with reference to FIGS. 2A-2C which depict side views of an embodiment of the liquid lens 130 with different applied voltages.

As depicted in FIGS. 2A-2C, an embodiment of the liquid lens 130 includes a chamber 200 having a window 230 through which the received optical signal 110 enters and a window 240 through which the modified optical signal 132 exits. Enclosed within the chamber 200 are two liquids 210 and 220. In one embodiment of the liquid lens 130, one of the liquids is a conductor, such as water, and the other liquid is an insulator, such as oil. The liquid lens 130 also includes electrodes 260A and 270A at a top end of the chamber 200, and electrodes 260B and 270B at a bottom end of the chamber 200. When voltages are applied to the electrodes, an interface 250 between the liquids deforms, forming a lens. The focal position and focal length of the liquid lens 130 may be adjusted by varying the voltages applied to the electrodes, which in turn varies the shape of the liquid-liquid interface 250.

For example, referring to FIG. 2A, applying a voltage of 60 Volts (V) across the top electrodes 260A and 270A and a voltage of 30 Volts (V) across the bottom electrodes 260B and 270B results in a wedge-shaped interface 250 that is tilted counterclockwise between the liquids 210 and 220. The wedge-shaped interface 250 modifies the received optical signal 110 that enters the chamber 200 through window 230 such that the modified optical signal 132 that exits through the window 240 is directed in a more downward direction when compared to the direction of the received optical signal 110.

Referring to FIG. 2B, applying a voltage of 45 Volts (V) across the top electrodes 260A and 270A and a voltage of 45 Volts (V) across the bottom electrodes 260B and 270B results in a convex interface 250 between the liquids 210 and 220. The convex interface 250 causes rays of the received optical signal 110 to converge such that the modified optical signal 132 has a narrower beam width than the received optical signal 110 when detected by the detector 150.

Referring to FIG. 2C, applying a voltage of 30 Volts (V) across the top electrodes 260A and 270A and a voltage of 60 Volts (V) across the bottom electrodes 260B and 270B results in a wedge-shaped interface 250 between the liquids 210 and 220 that is tilted clockwise. The wedge-shaped interface 250 causes the optical signal input into the window 230 to deviate upward as it exits through the window 240. The wedge-shaped interface 250 shown in FIG. 2C modifies the received optical signal 110 that enters the chamber 200 through window 230 such that the modified optical signal 132 that exits through the window 240 is directed in a more upward direction when compared to the direction of the received optical signal 110.

By varying the voltages applied to the top electrodes 260A and 270A and/or the bottom electrodes 260B and 270B, the focal length of the lens formed by the interface between the liquids 210 and 220 can be adjusted, e.g., the lens may be made concave or convex, to correct for blur. Tilt may be simultaneously corrected for by varying the voltages applied to the top electrodes 260A and 270A and/or the bottom electrodes 260B and 270B to adjust the focal position of the lens formed by the interface 250 between the liquids 210 and 220, i.e., causing the lens to tilt clockwise or counterclockwise. The focal length and/or focal position of the liquid lens 200 may be adjusted in a repeatable manner at a high repetition rate. The voltages needed to cause desired corrections for different measured levels of blur and tilt may be determined in advance and stored in memory 190 which may be included in or accessed by the lens adjuster 180.

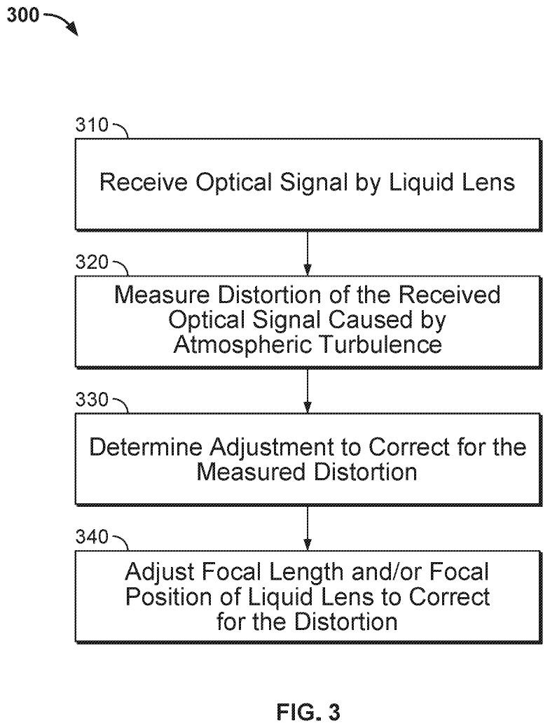

FIG. 3 is a flow chart showing steps of a process or method for correcting distortion in an optical signal caused by atmospheric turbulence according to an illustrative embodiment. It should be appreciated that fewer, additional, or alternative steps may also be involved in the process and/or some steps may occur in a different order.

Referring to FIG. 3, the process 300 begins at step 310 at which an optical signal passed through an atmosphere is received by a liquid lens, such as the liquid lens 130 shown in FIG. 1. At step 320, distortion of the received optical signal caused by turbulence in the atmosphere is measured. This step may be performed by a distortion sensor, such as the distortion sensor 170 shown in FIG. 1. At step 330, an adjustment of at least one of a focal position and a focal length of the liquid lens to correct for the measured distortion is performed. This step may be performed by a lens adjuster, such as the lens adjuster 180 shown in FIG. 1. At step 340, at least one of the focal length and the focal position of the liquid lens is adjusted to correct for the distortion. This step may be performed by the liquid lens 130, responsive to one or more signals, e.g., voltages, output from the lens adjuster 180.

The embodiments described herein leverage the high speed adaptiveness of a liquid lens to correct for distortion in an optical signal caused by atmospheric turbulence in near real-time. A liquid lens is smaller, weighs less, uses less power, has a faster response time, and is less costly than a traditional mirror-based distortion correction system. Additionally, using a liquid lens for distortion correction provides for reduced vibration sensitivity with a minimal field of view.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A method, comprising:
receiving, by a liquid lens, an optical signal passing through an atmosphere;
measuring distortion of the received optical signal caused by turbulence in the atmosphere;
determining an adjustment of at least one of a focal position and a focal length of the liquid lens to correct for the distortion; and
adjusting at least one of the focal position and the focal length of the liquid lens to correct for the distortion.

2. The method of claim 1, wherein measuring the distortion includes measuring blur of the received optical signal.

3. The method of claim 2, wherein the focal length of the liquid lens is adjusted to correct for the blur.

4. The method of claim 1, wherein measuring the distortion includes measuring tilt of the received optical signal.

5. The method of claim 4, wherein the focal position of the liquid lens is adjusted to correct for the tilt.

6. The method of claim 1, wherein measuring the distortion includes measuring blur and tilt of the received optical signal.

7. The method of claim 6, wherein the focal length and the focal position of the liquid lens are simultaneously adjusted to correct for the blur and the tilt, respectively.

8. A device, comprising:
a liquid lens configured to receive an atmosphere-distorted optical signal;
at least one distortion sensor optically coupled to an output of the liquid lens and configured to measure characteristics indicative of blur and tilt of the optical signal; and
at least one lens adjuster communicatively coupled to the distortion sensor, the liquid lens, and a memory, wherein the lens adjuster is configured to:
compare the measured characteristics to expected characteristics stored in the memory,
determine an adjustment in a focal length and a focal position of the liquid lens based on the comparison of the measured characteristics to the expected characteristics, and
output a signal to the liquid lens to adjust of the focal length and the focal position of the liquid lens so as to respectively correct for blur and tilt caused by atmospheric distortion.

9. The device of claim 8, wherein the received optical signal is fed to the at least one distortion sensor from the liquid lens by a beam splitter.

10. The device of claim 8, wherein the at least one distortion sensor is configured to measure a number of high frequency components in the received optical signal.

11. The device of claim 8, wherein the at least one distortion sensor includes a quadrant cell detector.

12. The device of claim 8, wherein the at least one distortion sensor includes a wavefront sensor.

13. The device of claim 8, wherein the at least one distortion sensor includes an image quality metric sensor.

14. The device of claim 8, wherein the at least one distortion sensor includes a camera, and wherein the tilt is measured based on a beam spot position of the received optical signal as detected by the camera.

15. The device of claim 14, wherein the at least one lens adjuster is included in the camera.

16. The device of claim 8, wherein the distortion sensor includes a camera, and wherein the blur is measured based on a beam spot size of the received optical signal as detected by the camera.

17. The device of claim 15, wherein the lens adjuster is included in the camera.

18. A system, comprising:
a first liquid lens configured to receive an optical signal passed through an atmosphere;
a first feedback device including:
a first distortion sensor configured to measure blur of the received optical signal caused by turbulence in the atmosphere; and
a first lens adjuster configured to:
determine an adjustment in a focal length of the first liquid lens to correct for the blur; and
output a first signal to the first liquid lens to cause the focal length to be adjusted to correct for the blur;
a second liquid lens configured to receive the optical signal passed through the atmosphere; and
a second feedback device including:
a second distortion sensor configured to measure tilt of the received optical signal caused by turbulence in the atmosphere;
a second lens adjuster configured to:
determine an adjustment in a focal position of the second liquid lens to correct for the tilt; and
output a second signal to the second liquid lens to cause the focal position to be adjusted to correct for the tilt.

19. The system of claim 18, further comprising:
a first beam splitter configured to feed the received optical signal from the first liquid lens to the first feedback device; and
a second beam splitter configured to feed the received optical signal from the second liquid lens to the second feedback device.

20. The system of claim 19, further comprising a detector configured to detect the received optical signal, wherein the first beam splitter and the second beam splitter are further configured to feed the received optical signal to the detector.
